(19) United States
(12) Patent Application Publication
(10) Pub. No.: US 2005/0089671 A1
(43) Pub. Date: Apr. 28, 2005

(54) Shaped sheet and method for producing the same

(76) Inventor: Takeshi Kubota, Tokyo-to (JP)

Correspondence Address: SEYFARTH SHAW, 55 EAST MONROE STREET, SUITE 4200, CHICAGO, IL, 60603-5803, US

(21) Appl. No.: 10/997,489

(22) Filed: Nov. 24, 2004

Related U.S. Application Data
(62) Division of application No. 09/720,584, filed on Dec. 22, 2000, now abandoned.

(30) Foreign Application Priority Data
Apr. 23, 1999 (JP) 11-115743

(51) Int. Cl. B32B 1/00

(52) U.S. Cl. 428/143

(57) ABSTRACT

An object of the present invention is to fairly reproduce the irregular surface of a shaped sheet for a cast resin film and a production method having high productivity. In order to attain the above object, the present invention provides a shaped sheet provided with a releasable resin layer having a transfer pattern formed of an irregular shape on one side of a substrate sheet 1, wherein a flat portion of the transfer pattern is formed of an fine irregular surface having an arithmetic average roughness Ra of 30.0 to 1.5 μm.

### TECHNICAL FIELD

The present invention relates to a shaped sheet used to produce a resin coating of a synthetic resin by a casting method, and, particularly, to a composite shaped sheet used in a step of providing an artificial leather with an irregular shape when the artificial leather is manufactured.

### BACKGROUND ART

In a conventional method of the production of an artificial leather, a releasing sheet or a shaped sheet is used to form a resin coating from a synthetic resin solution by a casting method and thereafter the resin coating is laminated on a ground fabric. In the casting method, a solution or molten composition comprising a natural or synthetic resin having qualities similar to an artificial leather is used to form a uniform resin coating on a releasable resin layer of a shaped sheet by application. Next, the resin coating is laminated on the ground fabric by, as desired, preparing an adhesive layer. After that, the adhesive layer is dried or cured to the extent that no hindrance to successive processing is placed and then the shaped sheet is peeled off and removed. Further, a pattern layer is directly printed on the surface of the aforementioned resin coating or formed by transfer printing to provide a leather pattern or an abstract pattern and surface treatment is performed using a non-colored transparent or transparent colored paint with the intention of preventing the falling of printing ink and to regulate the surface glossiness thereby manufacturing a product.

In the aforementioned surface decorative method, a colorful surface is obtained but the surface exhibits a flat feeling and a leather like appearance which is three-dimensional and which has a high design value cannot be obtained. In such a case, a shaped sheet formed with an irregular shape by embossing a releasable resin layer of the releasing sheet is used to form thick and thin parts of the resin coating thereby providing a three-dimensional feeling and expressing color shading by varied thickness parts of the colored resin coating.

However, in the production of a releasing sheet formed with a transfer pattern, namely a shaped sheet, a negative pattern is formed on a releasable resin layer which is made up of a thermoplastic resin and formed on a substrate sheet by embossing processing using an embossing roll corresponding to a positive plate having the irregularity of a leather to form the shaped sheet.

As to this irregular shape, a releasable resin layer which is made of a thermoplastic resin and formed on a substrate sheet is put in a molten state by heating to form a desired irregular shape by the aforementioned embossing roll. In order to reproduce the pattern of the embossing roll fairly in the production of the aforementioned irregular pattern, it is necessary to melt the releasable resin layer by sufficient heating and to perform the transfer of the pattern (a positive pattern in general) of the embossing roll and cooling exactly. Therefore, this conventional method needs the time required for uniform heating, the pressure required to insert the embossing roll for embossing and the time required for cooling, resulting in remarkably low productivity and it is difficult to reproduce the pattern of the embossing roll fairly and stably.

### SUMMARY OF THE INVENTION

In order to solve the above problem, it is an object of the present invention to provide a shaped sheet in which a predetermined pattern is fairly reproduced in the embossing processing of the shaped sheet and also to provide a production method superior in productivity.

The above object can be attained by a shaped sheet according to the present invention, the shaped sheet being provided with a releasable resin layer having a transfer pattern formed of an irregular shape on one side of a substrate sheet to form a resin coating having an irregular shape by casting from a solution of a reactive or thermoplastic resin or a thermally molten composition, wherein a flat portion of the transfer pattern is formed of an irregular surface having an arithmetic average roughness Ra of 30.0 to 1.5 μm.

In the invention, the shaped sheet may be provided with a fine irregular surface having a maximum height Ry of 100.0 to 10.0 μm by the transfer pattern.

Also, the above object can be attained by a method of producing a shaped sheet according to the present invention, the shaped sheet being provided with a releasable resin layer having a transfer pattern formed of an irregular shape on one side of a substrate sheet to form a resin coating having an irregular shape by casting from a reactive or thermoplastic resin solution or thermally molten composition, the method comprising forming a releasing sheet in which the releasable resin layer of the substrate sheet has a fine irregular surface with an arithmetic average roughness Ra of 2.0 to 0.3 μm and then performing embossing processing so as to form an irregular shape on the releasable resin layer such that a flat portion of the formed transfer pattern is formed of a fine irregular surface having an arithmetic average roughness Ra of 30.0 to 1.5 μm.

The present invention, as mentioned above in detail, comprises forming a fine irregular surface on a releasable resin of the releasing sheet and performing embossing processing to transfer the irregular pattern of the embossing roll. For this reason, the convex portion of the embossing roll is inserted deeply into the releasable resin and thus the present invention produces the effect of forming a shaped sheet having a fine irregular surface in which the state of the concave portion of the embossing roll is fairly reproduced in the fine irregular surface.

### BRIEF DESCRIPTION OF THE DRAWINGS

FIG. 1 is a conceptional view showing a section of a shaped sheet according to the present invention.

FIG. 2(A) is a sectional view of a releasing sheet showing the state of a shaped sheet according to the present invention prior to embossing processing, FIG. 2(B) is a conceptional view of a section showing the situation where a shaped sheet according to the present invention is subjected embossing processing, and FIG. 2(C) is a conceptional view showing a section of a completed shaped sheet according to the present invention.

FIG. 3(A) is a schematically sectional view of a releasing sheet for producing a shaped sheet according to a conventional method, FIG. 3(B) is a conceptional view of a section showing the situation where a shaped sheet is subjected embossing processing according to the conventional method, and FIG. 3(C) is a conceptional view showing the section of a completed shaped sheet according to the conventional method.

FIG. 4(A) is an imaginary view showing the condition of an embossing using an embossing roll in the present invention, and FIG. 4(B) is an imaginary view showing the condition of an embossing using an embossing roll in a conventional method.

### PREFERRED EMBODIMENTS OF THE INVENTION

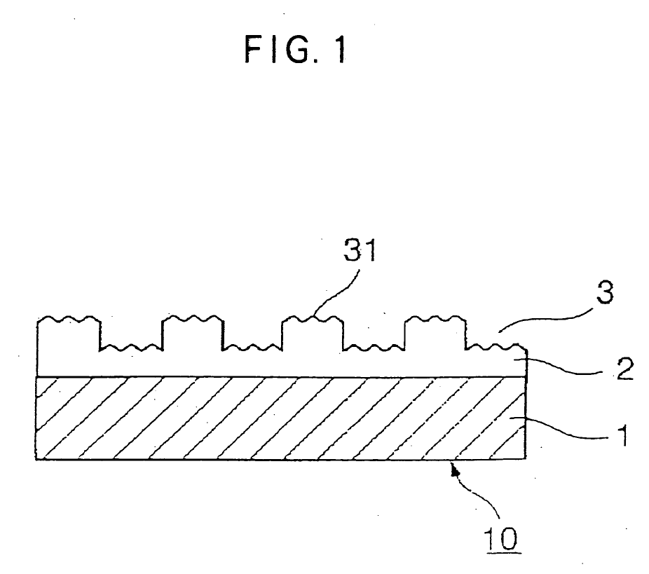

A shaped sheet according to the present invention is, as shown in FIG. 1, a shaped sheet 10 which is provided with a releasable resin layer having an transfer pattern 3 formed of an irregular shape on one side of a substrate sheet 1 and forms a resin coating having an irregular shape by casting from a solution of a reactive or thermoplastic resin or a thermally molten composition, wherein a flat portion of the transfer pattern 3 is formed of a fine irregular surface 31 having an arithmetic average roughness Ra of 30.0 to 1.5 μm.

In the present invention, the shaped sheet 10 may be provided with a fine irregular surface having a maximum height Ry of 100.0 to 10.0 μm by the transfer pattern.

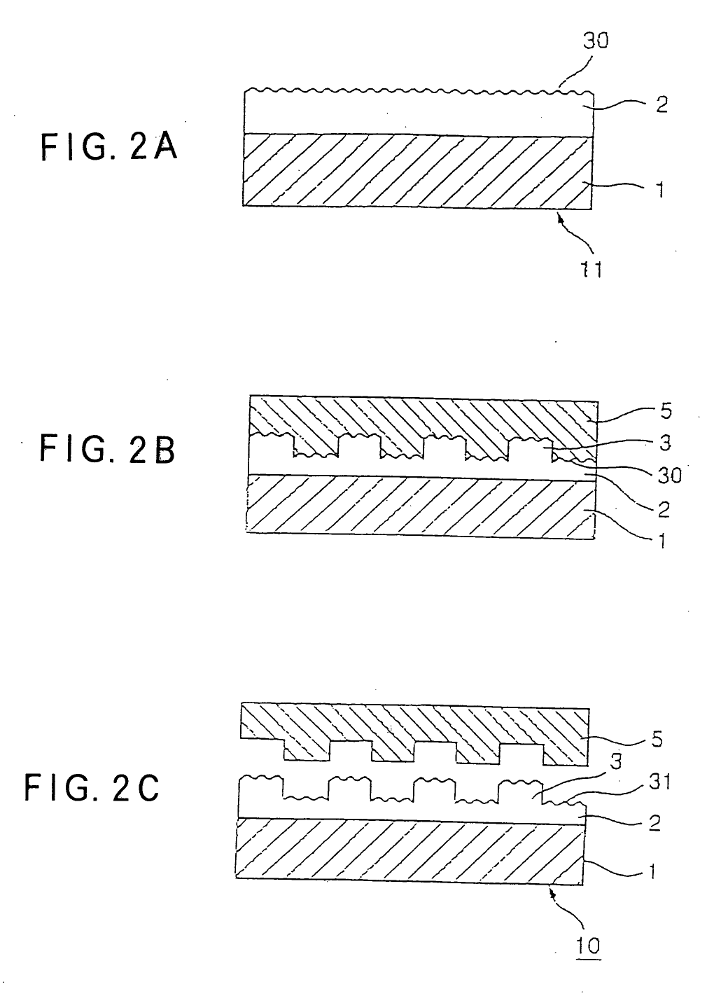

Also, as shown in FIG. 2(C), the present invention directs to a method of producing the shaped sheet 10 which is provided with a releasable resin layer 2 having the transfer pattern 3 formed of an irregular shape on one side of the substrate sheet 1 to form a resin coating having an irregular shape by casting from a reactive or thermoplastic resin solution or thermally molten composition, the method comprising forming a releasing sheet 11 in which the releasable resin layer 2 of the substrate sheet 1 has a fine irregular surface 30 with an arithmetic average roughness Ra of 2.0 to 0.3 μm as shown in 2(A).

Then performing embossing processing is performed, so as to form an irregular shape on the releasable resin layer 2 as shown in FIG. 2(B) such that a flat portion of the transfer pattern is formed of a fine irregular surface 31 having an arithmetic average roughness Ra of 30.0 to 1.5 μm as shown in FIG. 2(C).

The substrate sheet used for the shaped sheet of the present invention may be selected from sheet-like materials which are reduced in thickness variation and which are free from melt-cutting and deformation such as elongation or contraction caused by heat or solvents in a step of forming the releasable resin layer, the embossing processing and the step of forming a composition of an artificial leather by application.

Examples of the substrate sheet include paper such as unbleached kraft paper, unglazed kraft paper, machine grazed kraft paper, simili paper and wood free paper and nonwoven fabric constituted of a polyester, rayon or the like.

As to the thickness of the substrate sheet, those having a basis weight of 30 to 300 g/m² are preferable.

When a solution having releasability or a dispersion type material is applied to form the releasable resin layer, it is desirable to provide a filling layer on the surface of paper for the purpose of preventing the penetration of a coating solution. For the filling layer, a resin latex containing a filler such as calcium carbonate, barium sulfate, silica or clay is applied in an amount of 5 to 30 g/m² (solid content) and the surface of the layer may be made smooth by calendering according to the need. Also, a thermoplastic resin such as a polyolef in may be applied by melting extrusion coating to form the filling layer.

The releasable resin layer of the present invention is selected from materials which have releasability even after materials of an artificial leather is applied and formed as a film and which enable a transfer pattern to be maintained even if heat is applied during processing.

Examples of these materials include thermoplastic resins such as a polypropylene, high density polyethylene, silicone resin and polymethylpentene and also include materials, which are non-adhesive at ambient temperature and are cured by applying energy thereto after embossing processing, such as resins which are cured by ionizing radiation rays such as ultraviolet rays or electron rays and thermosetting resins such as alkyd resins in which a solid resin is blended.

When the releasable resin layer is formed using a thermoplastic resin, it is formed by heating and melting extrusion coating in the case where the resin consists of 100% of a solid and by the usual coating system such as gravure coating, roll coating, bar coating and air knife coating in the case where the resin is in the state of a solution or dispersion. Also, the releasable resin layer is structured by laminating a film, which is produced in a separate step and made of a releasable resin, either through the provision of an adhesive layer or by sandwich lamination through a heat meltable resin.

The fine irregular surface to be formed on the releasable resin layer used in the present invention may be embossed by a cooling roll when a thermoplastic resin which is a releasable resin layer is applied to the substrate sheet by melting extrusion coating or is formed by a T-dice method. Then, the arithmetic average roughness Ra of the fine irregular surface 30 shown in FIG. 2(A) is set to a range from 2.0 to 0.3 μm. When the roughness is larger than 2.0 μm, the fine irregular surface 30 is pressed insufficiently when the transfer pattern 3 is formed by the embossing roll 5 and the fine irregular surface 31 formed on the surface of the shaped sheet 10 is thereby increased in roughness as shown in FIG. 2(B). Therefore, the glossiness of a synthetic resin leather to be formed by casting is excessively degraded resultantly.

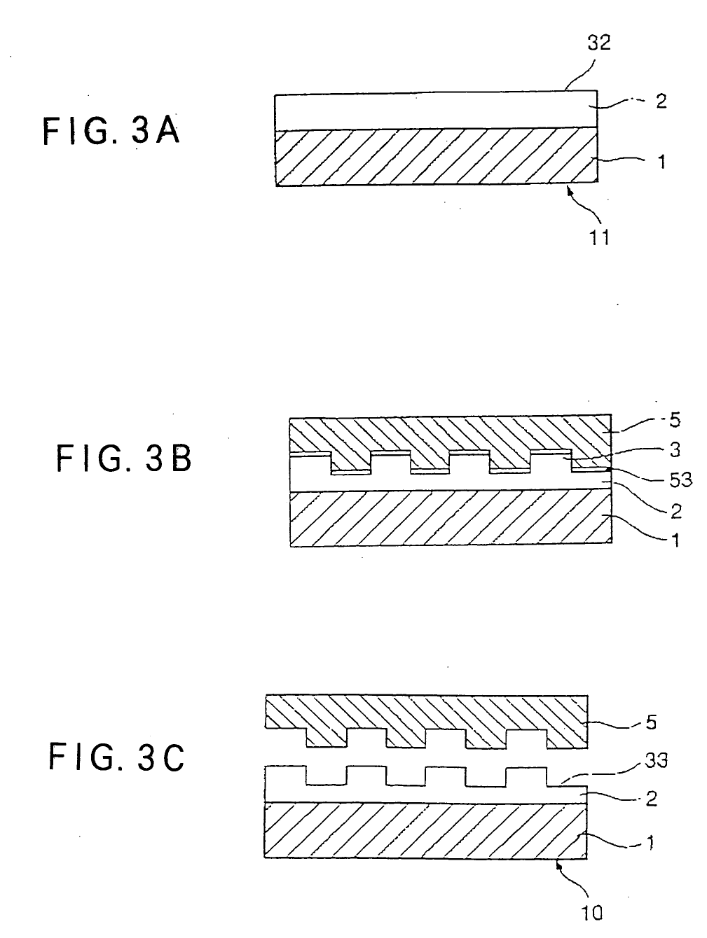

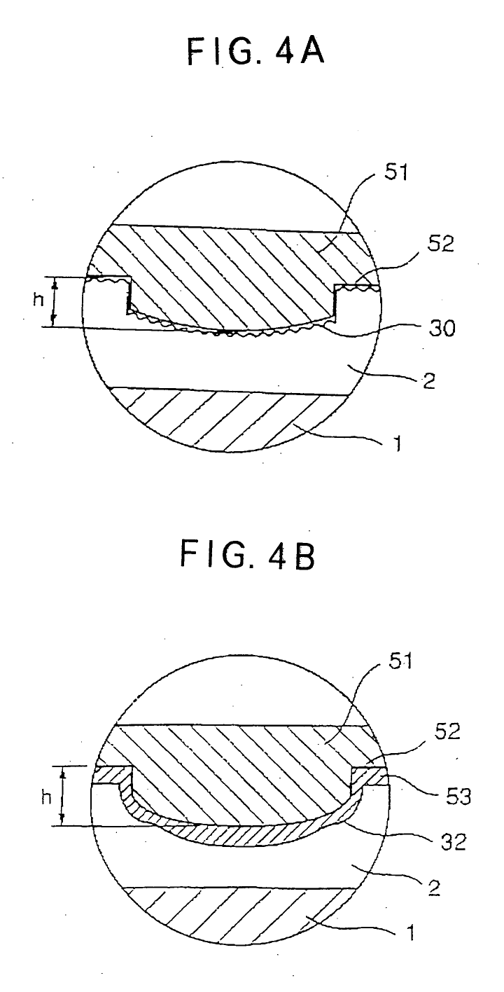

On the other hand, when the roughness is smaller than 0.3 μm, the fine irregular surface is close to a smooth surface 32 shown in FIG. 3(A). Further, even if stronger pressure is applied such that a convex portion 51 of the embossing roll reaches the releasable resin layer 2 completely as shown in FIG. 4(B) when the transfer pattern 3 is pressed by the embossing roll 5, a non-embossed portion 53 where the embossing roll is not in contact with the releasable resin is produced because of the intervention of gas between the convex portion 51 of the embossing roll and the releasable resin layer 2. As a result, in the transfer pattern 3 of the shaped sheet 10, a given depth cannot be attained. Therefore, the depth of a concave portion of an artificial leather to be formed by casting using such a shaped sheet is insufficient and uneven.

When the releasing sheet having an arithmetic average roughness Ra of 2.0 to 0.3 μm is subjected to embossing processing, the bite of the embossing roll at the releasing sheet does not always depends on the height of the embossing. Specifically, those having higher transfer pattern, that is, a larger pattern tend to have higher adaptability to embossment. A high embossing effect is produced particularly in the case of a shaped sheet formed with fine irregular surface having a maximum height Ry of 100.0 to 10.0 μm according to the height of the embossing, namely the transfer pattern. When the maximum height of the transfer pattern is 10.0 μm or less, a difference in each of embossing height, unevenness and glossiness is small even if a releasing sheet having an arithmetic average roughness Ra of 0.3 μm or less is used. When the maximum height of the embossing pattern is 100.0 μm or more, the embossing roll strongly bites at the releasable resin layer, requiring large force to peel off the releasable layer from the embossing roll. Specifically, if embossing speed is not lowered, no operation is continued, resulting in reduced productivity.

As shown in FIG. 2(A), the transfer pattern 3 of the shaped sheet 10 of the present invention is formed on the surface of the releasable resin layer 2 of the releasing sheet 11 obtained by laminating the releasable resin layer 2 provided with the fine irregular surface 30 having an arithmetic average surface roughness Ra of 2.0 to 0.3 μm on the substrate sheet 1. Specifically, a paper roll as a backup roll, though not shown, is disposed on the side of the substrate sheet 1 of the releasing sheet 11 such that the embossing roll 5 provided with the transfer pattern 3 is brought into contact with the releasable resin layer 2. Then, the side of the releasable resin layer 2 is heated to the melting point thereof by using heating steam, a heating medium or an infrared heater and cooling and molding operations are performed to carry out embossing processing while pressure is applied by a cooled embossing roll as shown in FIG. 2(B) to form the shaped sheet 10 provided with the transfer pattern 3. At this time, the fine irregular surface 30 to be embossed is pressed by the embossing roll 5 and its flat portion is changed to the fine irregular surface 31 which is almost flat. Such a non-embossed portion as shown in FIG. 4(A) is not formed between the convex portion 51 of the embossing roll and the releasable resin layer. The transfer pattern 3 having a depth similar to that of a given one can be structured.

On the surface of the transfer pattern 3 of the shaped sheet formed according to the present invention, a heat resistant “resin varnish of a releasable composition” (not shown), may be formed by application. In this case, the resin layer forming the transfer pattern surface must unnecessarily have the releasability from a composition constituting an artificial leather.

A material used for the resin layer may be rather selected, placing great importance on transferability and heat resistance. For instance, resins which have non-adhesive plasticity at room temperature and which are cured by ionizing radiation such as ultraviolet rays or electron rays, curable resins of epoxy resins or saturated polyesters/polyisocyanate type resins or thermoplastic resins such as saturated polyesters, polyethylene or polyimides may be used by applying each of these resins or by laminating a film of each resin.

The aforementioned resin varnish of a releasable composition is preferably formed by application as a thin film layer with a thickness of the order of 0.2 to 2 μm. Examples of materials used for the composition include silicone, fluororesins, thermosetting resins such as an aminoalkyd and ionizing radiation-curable resins prepared properly from a prepolymer, oligomer and/or monomer having a polymerizable unsaturated bond or an epoxy group in a molecule.

As to the application of the releasable composition, the composition which is diluted by solvent as required such that it has a viscosity as low as possible is uniformly applied so as to extend to the concave portion of the shaped sheet by a coating method such as gravure or roll coating (direct or reverse), air knife coating, curtain coating or bar coating. Heat or ionizing radiation is applied in accordance with the qualities of the coating solution to cure the solution thereby modifying the releasability of the irregular surface and heat resistance.

Also, it is desirable to perform corona discharge treatment on the coating surface provided with an irregular pattern thereby allowing the coating surface to adhere to the releasable resin varnish firmly and stably.

Ra (arithmetic average roughness) and Ry (maximum height) used in the present invention were measured by the following measuring method and measuring condition. (Measuring method) Measurements were made based on Japanese Industrial Standards (JIS B 0601-1994) [Surface roughness-Definition and Indication]. International Standards corresponding to this Japanese Standards are shown below.
ISO 468-1982 (Surface roughness—Parameters, their values and general rules for specifying requirements)
ISO 3274-1975 (Instruments for the measurement of surface roughness by the profile method—Contact (stylus) instruments of consecutive profile transformation - Contact profile meters, system M)
ISO 4287/1-1984 (Surface roughness—Terminology Part 1: Surface and its parameters)
ISO 4287/2-1984 (Surface roughness—Terminology Part 2: Measurement of surface roughness parameters)
ISO 4288-1985 (Rules and procedures for the measurement of surface roughness using stylus instruments)

(Measuring condition)

Radius of the tip of a tracer: 5 μm

Load: 4 mN

Cutoff value: Standard values described in Table 1 were selected.

Standard length: Standard values described in Table 2 were selected.

Measuring instruments: surface roughness measuring device Suftest-201 manufactured by Mitsutoyo

TABLE 1

| | | |
|---|---|---|
| Range of Ra | Cutoff value | Evaluated length |
| (μm) | λ c | l n |

| Exceeding | Less than | (mm) | (mm) |
|---|---|---|---|
| (0.006) | 0.02 | 0.08 | 0.4 |
| 0.02 | 0.1 | 0.25 | 1.25 |
| 0.1 | 2.0 | 0.8 | 4 |
| 2.0 | 10.0 | 2.5 | 12.5 |
| 10.0 | 80.0 | 8 | 40 |

Numerals in ( ) are reference values

TABLE 2

| | | |
|---|---|---|
| Range of Ry | | Evaluated length |
| (μm) | Standard length l | l n |

| Exceeding | Less than | (mm) | (mm) |
|---|---|---|---|
| (0.025) | 0.10 | 0.08 | 0.4 |
| 0.10 | 0.50 | 0.25 | 1.25 |
| 0.50 | 10.0 | 0.8 | 4 |
| 10.0 | 50.0 | 2.5 | 12.5 |
| 50.0 | 200.0 | 8 | 40 |

Numerals in ( ) are reference values

### EXAMPLES

The present invention will be hereinafter explained in more detail by way of examples.

### Example

A polypropylene (releasable resin 2) was applied on one surface of a simili paper (substrate sheet 1) weighing 52 g/m² in a thickness of 30 μm by using a T-die melting extrusion coater provided with a cooling roll having an irregular pattern with an arithmetic average roughness Ra of 1 μm to produce a releasing sheet 11 having a fine irregular surface 30 shown in FIG. 2(A). The fine irregular surface at this time had an arithmetic average roughness of 0.7 μm, a cutoff value of 0.8 mm and an evaluated length of 4 mm.

Next, a paper roll and an embossing roll with a convex portion 51 having a height of h were placed on an embossing processing machine. The above releasing sheet 11 was preheated to 120° C. and the embossing roll 5 cooled to 10° ° C. was used to transfer the pattern under cooling at a pressure of 60 kg/cm² as shown in FIG. 2(B) thereby producing a shaped sheet 10 having a transfer pattern 3. The fine irregular surface 31 of the shaped sheet 10 as shown in FIG. 2(C) was formed in a manner that it was brought into contact with the convex portion of a master roll in the condition shown in FIG. 4(A). The surface condition of the aforementioned fine irregular surface 31 was as follows: arithmetic average roughness: 0.1 μm, cutoff value: 0.25 mm and evaluated length: 1.25 mm. The depth in the surface condition of the transfer pattern 3 almost corresponded to the convex portion 51 having a height of 50 μm which was formed on the embossing roll 5. Also, the maximum height was 45 μm, the standard length was 0.25 mm and the evaluated length was 1.25 mm.

### Comparative Example 1

A polypropylene (releasable resin 2) was applied on one surface of a simili paper (substrate sheet 1) weighing 52 g/m² in a thickness of 30 μm by using a T-die melting extrusion coater provided with a cooling roll having an irregular pattern with an arithmetic average roughness Ra of 0.3 μm to produce a releasing sheet 11 having a smooth surface 32 shown in FIG. 3(A). The fine irregular surface corresponding to the smooth surface at this time had an arithmetic average roughness of 0.2 μm, a cutoff value of 0.8 mm and an evaluated length of 4 mm.

Next, the above releasing sheet 11 was placed on an embossing machine provided with a paper roll and a master plate 5 and was preheated to 120° C. An embossing roll cooled to 10° C. was used to transfer the pattern under cooling at the same pressure as in Example 1 as shown in FIG. 2(B) thereby forming a transfer pattern 3 shown in 2(C).

However, the convex portion 51 of the embossing roll could be inserted insufficiently as shown in FIG. 3(B) or FIG. 4(B), so that a non-embossed portion 53 was produced. For this reason, a pressure 1.7 times that of Example 1 was applied so that the concave portion 52 of the embossing roll was perfectly brought into contact with the releasing sheet 11 to form a shaped sheet 10 as a comparative example.

The surface condition of the aforementioned transfer irregular surface 33 of the shaped sheet 10 was as follows: arithmetic average roughness: 0.1 μm, cutoff value: 0.25 mm and evaluated length: 1.25 mm. This surface condition was not almost different from that of the smooth surface 32 of the releasing sheet.

The depth in the surface condition of the transfer pattern 3 corresponded to 0.6 times the height, namely 50 μm, of the convex portion 51 formed on the embossing roll 5. Also, the maximum height was 30 μm, the standard length was 0.25 mm and the evaluated length was 12.5 mm showing that the embossing pattern was insufficiently transferred.

### Comparative Example 2

A polypropylene (releasable resin 2) having a thickness of 30 μm was applied on one surface of a simili paper (substrate sheet 1) weighing 52 g/m² by using a T-die melting extrusion coater, though not shown, provided with a cooling roll having an irregular pattern with an arithmetic average roughness Ra of 3 μm to produce a releasing sheet 11. The fine irregular surface at this time had an arithmetic average roughness of 2.2 μm, a cutoff value of 2.5 mm and an evaluated length of 12.4 mm.

Next, the above releasing sheet 11 was subjected to embossing processing conducted in the same manner as in Example 1 to form a transfer pattern.

The surface condition of the aforementioned transfer irregular surface 33 of the shaped sheet 10 was as follows: arithmetic average roughness: 0.1 μm, cutoff value: 0.25 mm and evaluated length: 1.25 mm. This surface condition was not almost different from that of the fine irregular surface of the releasing sheet. However, the maximum roughness was larger than that of Example 1 and the surface exhibited an uneven condition. Also, the depth in the surface condition of the transfer pattern 3 almost corresponded to the convex portion 51 having a height of 50 μm which was formed on the embossing roll 5. Also, the maximum height was 45 μm, the standard length was 0.25 mm and the evaluated length was 1.25 mm.

Using these shaped sheets prepared in Examples and Comparative Examples, a colored polyurethane paint was applied to each of these sheets in an amount of 80 g/m² (solid content) by using a knife coater with a clearance set to 250 μm. After the paint was dried, the sheet was laminated on a white fabric to obtain an artificial leather having an irregular pattern. The results of evaluation of the surface condition of the formed artificial leather by visual observation are as shown in Table 3.

TABLE 3

| | | Comparative | Comparative |
|---|---|---|---|
| Sample | Example 1 | Example 1 | Example 2 |
| Depth of | Good | Shallow | Good |
| irregularity | | | |
| Unevenness of | Good | Exist slightly | Generation of |
| the surface | | | unevenness |
| Glossiness of | Good | Good | Deficient |
| the surface | | | glossiness |

1. A shaped sheet provided with a releasable resin layer having a transfer pattern formed of an irregular shape on one side of a substrate sheet to form a resin coating having an irregular shape by casting from a solution of a reactive or thermoplastic resin or a thermally molten composition, wherein a flat portion of the transfer pattern is formed of an fine irregular surface having an arithmetic average roughness Ra of 30.0 to 1.5 m.

2. A shaped sheet according to claim 1, wherein the shaped sheet is provided with a fine irregular surface having a maximum height Ry of 100.0 to 10.0 μm by the transfer pattern.

3. A method of producing a shaped sheet provided with a releasable resin layer having a transfer pattern formed of an irregular shape on one side of a substrate sheet to form a resin coating having an irregular shape by casting from a reactive or thermoplastic resin solution or thermally molten composition, the method comprising forming a releasing sheet in which the releasable resin layer of the substrate sheet has a fine irregular surface with an arithmetic average roughness Ra of 2.0 to 0.3 μm and then performing embossing processing so as to form an irregular shape on the releasable resin layer such that a flat portion of the transfer pattern is formed of a fine irregular surface having an arithmetic average roughness Ra of 30.0 to 1.5 μm.
